(19) United States
(12) Patent Application Publication
(10) Pub. No.: US 2006/0230145 A1
(43) Pub. Date: Oct. 12, 2006

(54) Methods and systems for a multi-service federated content distribution network

(75) Inventors: Yevgeny Zarakhovsky, Seattle, WA (US); Karim M.T. Farouki, Seattle, WA (US); Brent Lee Ingraham, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/101,850

(22) Filed: Apr. 8, 2005

(51) Int. Cl. G06F 15/173

(52) U.S. Cl. 709/225

(57) ABSTRACT

The multi-service federated content distribution network provides a flexible directory service to define a set of service providers which clients are permitted to use. The directory service interfaces with other computing devices of two types: Either the computing devices includes a group of service providers that want to provide their copyrighted material to users using the directory service; or, the computing devices includes a group of users who have connected to the service providers through web browsing and now desire to download content from the service providers. The directory service facilitates activities to both groups using a digital rights management (DRM) approach.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

This invention relates to the field of computer hardware and software. More particularly, it involves facilitating the use of a central service to allow different entities to provide their digital works of art from the central service to users. It incorporates network activities, authentication techniques, database management, and digital rights management.

### BACKGROUND OF THE INVENTION

With the availability of digital media, content delivery networks have become more readily available to users of the internet. Content delivery networks vary across a wide spectrum from the sophisticated entities that provide various digital works of arts with digital rights management (DRM) to the small developer providing a limited access to digital content with no licensing requirement. Alternatively, there are various entities that make available their digital works of arts to the public, but neither have the platform nor the resources to provide the requisite access. It would be advantageous to these entities to have a means to provide their content to the public without a significant amount of investment in time or money.

Paralleling the situation above, DRM has enabled copyrighted works to be delivered over the internet to potential users who comply with the DRM scheme. The DRM scheme involves registering with the copyright owner and receiving a DRM license in order to download a digital audio, video, or document file that resides within the servers of the copyright owner. As this approach provides a mechanism for users to obtain digital works of art, it may impose a burden on the copyright owner to create and maintain the necessary infrastructure in order to enable this DRM approach. In addition, the volume of users may be so overwhelming that the infrastructure of the copyright owner may become congested and unable to handle the demands imposed on it. For example, a music company may have a website containing access to a popular set of songs. The songs may prove to be so popular that the music company's website may crash trying to service the demands of users that might want the songs. It is well known that the music company is in the business of making music available and selling it in the traditional manner, such as on a CD. Although for some music companies, the digital age has pushed them to offer songs through the internet, and this approach is growing everyday. It is plausible that an overwhelming demand to a website might prove disastrous.

Content delivery networks tend to be either centrally managed or peer-to-peer networks. This results in either a very tight or loose control for the potential user desiring to obtain digital content from a content delivery network. With a centrally managed network, the owner of the network has complete control over the access and manner of dissemination of any digital content. This means that a potential user must work within the guidelines of the content owner in order to obtain the digital content. Unfortunately, the rules and requirements vary from one content delivery network to another. For example, one video company may require a user to provide an extensive amount of personal information while another video company may require only the pre-payment of a fee in order to obtain the digital content. Alternatively, a peer-to-peer network may have very little control or security checks. These networks tend to provide an exchange of information between two computing devices. Digital works of art may be transferred from one user to another without paying a right-to-use fee or obtaining a license.

Content delivery networks may be implemented without a DRM scheme. It is preferential to have this scheme but it is not mandatory. As noted by the peer-to-peer networks, some entities may provide access to their digital works of art without any protective mechanism, or they may provide access to the digital works of art of others. The point here is to convey that DRM is not required when operating a content delivery network.

With various content delivery networks, a complement of software is involved to enable a user to use a content delivery service. There is software operated by a content provider and software that resides on the user's computing device in order to interact with the content delivery network. The user downloads or installs a client software from the content provider. This means that the user may have to install client software from each content provider that the user wants to access. This can become cumbersome for the user. The user has to keep track of the different content providers that the user may access. For the computing device, resources may become constrained with the downloading of different software which may result in software conflicts. Today, if the user wants to download digital music from content provider A, a video from content provider B, and a document from content provider C, the user has to download specific client software from each content provider to interact with their specific content delivery network. As can be seen, disk space and probably processing speed can be impacted. In addition, numerous content providers have written numerous client software programs that vary greatly and operate differently. As one can see, the user may be forced to deal with multiple content providers at once (operating all client software at once on a single computing device). The various client software may impact bandwidth to handle multiple transactions such as downloading software, making download priorities difficult.

For those entities less fortunate, client software, mentioned above, is difficult to develop and maintain. Client software is one of the most important reasons to use content delivery networks. Content providers control access to digital works of arts through the use of client software. Unfortunately, many content providers do not have the expertise to develop client software and do not have the infrastructure to offer digital content to users.

The present invention provides an approach to overcome the limitations stated above. The present invention creates a federated content delivery network that interfaces with multiple business partners to provide digital content to users. It provides a platform to enable content providers to deliver their digital works of arts to the public, especially those content providers that do not have the necessary means to develop client software. Furthermore, it provides a single client software rather than a multitude of client software written by various content providers. With the present invention, the user's computing device may be relieved from the problems discussed above with regards to the download of various client software, and software updates become streamlined to one client software that benefits all content providers. Finally, for those content providers in need, the present invention incorporates a DRM approach for those business partners that require it to protect against piracy and unauthorized uses of digital content.

### BRIEF SUMMARY OF THE INVENTION

The present invention provides a flexible approach to allow a central service to obtain digital media over the internet from copyright owners, assignees, or other authorized users and deliver it to users. This disclosure describes, among other things, methods and systems for providing a multi-service federated content distribution network.

A method for providing a central content distribution network is implemented that includes a computing device containing a directory service. The directory service operates to allow a set of service providers to deliver content to clients. The directory service registers the clients to a subset of the service providers and facilitates the delivery of content from a service provider to a client.

A system for operating a federated delivery network is also provided that includes a computing device operable in a network to maintain a central directory service and to maintain network connections to service providers and clients. The central directory service is operable to control which service providers are permitted in the network to provide content to the clients and to maintain a description of the allowed services from the service providers.

A method is also provided for operating a federated delivery network. The method includes maintaining a central directory service at a computing device. The computing device operates with a network connection to service providers and clients. The central directory service controls which service providers are permitted in the network to provide content to the clients. A description is maintained at the computing device with the allowed services from the service providers.

### BRIEF DESCRIPTION OF THE SEVERAL VIEWS OF THE DRAWINGS

The present invention is described in detail below with reference to the attached drawing figures, which are incorporated herein by reference, and wherein:

FIG. 1 is a block diagram of an exemplary operating environment suitable for practicing an embodiment of the present invention;

FIG. 2 is a block diagram of an exemplary network environment illustrating an embodiment of the present invention;

FIG. 3 is a block diagram of an exemplary communication exchange illustrating an embodiment of the present invention;

FIG. 4 is a flowchart illustrating an embodiment for implementing the present invention;

FIG. 5 is a flowchart illustrating an embodiment of an exemplary operating process for the present invention; and

FIG. 6 is a second block diagram of an exemplary network environment illustrating an embodiment of the present invention.

### DETAILED DESCRIPTION OF THE INVENTION

The present invention will be better understood from the detailed description provided below and from the accompanying drawings of various embodiments of the invention, which describe, for example, methods and systems for providing a multi-service federated content distribution network. The detailed description and drawings, however, should not be read to limit the invention to the specific embodiments. Rather, these specifics are provided for explanatory purposes that help the invention to be better understood.

The multi-service federated content distribution network provides a flexible directory service that operates on a computing device. The directory service interfaces with other computing devices of two types: Either the computing devices include a group of service providers that want to provide their copyrighted material to users using the directory service; or, the computing devices include a group of users who have connected to the service providers through web browsing and now desire to download content from the service providers. The directory service facilitates activities to both groups. In addition, the directory service implements a federated approach with the service providers based on the service providers' needs.

Having briefly described an overview of the present invention, an exemplary operating environment for the present invention is described below.

Exemplary Operating Environment

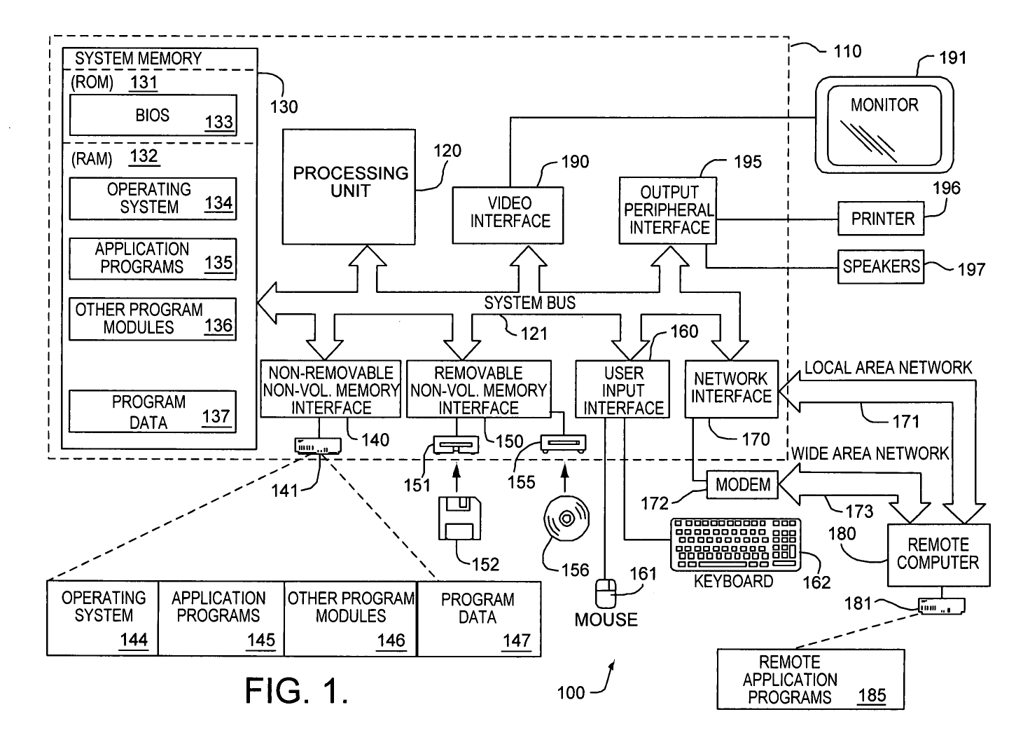

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between the various steps herein disclosed unless and except when the order of individual steps is explicitly described.

Federated Content Distribution Network

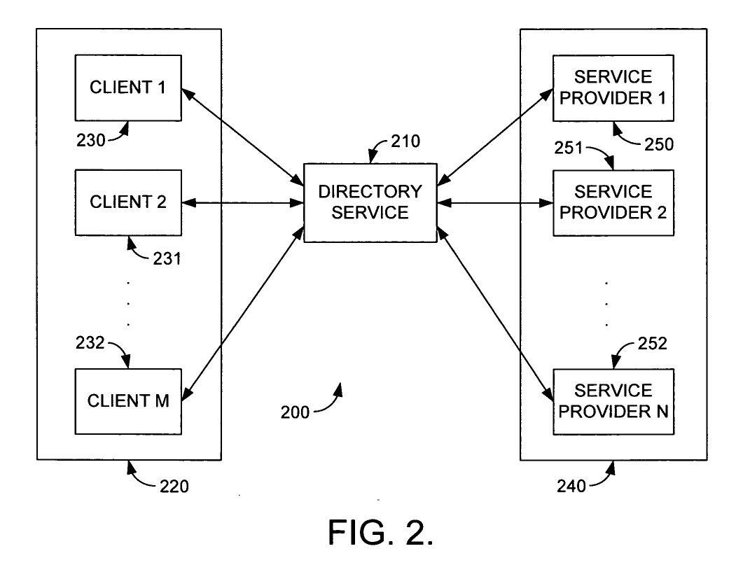

In FIG. 2, a block diagram is shown illustrating an embodiment of the present invention. Network 200 illustrates a DRM service incorporating a directory service 210. Directory service 210 can connect to clients 220 and service providers 240 with a variety of connections or federation. Directory service 210 operates as part of a computing device. The computing device may be a computer, server, or switch. Also, the computing device may be a series of servers and computers connected together. The term federation or federated is used in this specification to identify the dynamic types of relationships that may exist between directory service 210, clients 220, and service providers 240. As will be shown below, a relationship may exist between directory service 210 and a service provider where the service provider lacks the infrastructure to provide a DRM service. Directory service 210 may perform most of the functions on behalf of the service provider. In another setup, the service provider may have a large infrastructure and desire a considerable amount of independence and control in managing most of its own DRM service. In this case, directory service 210 may perform minimal verification functions. The point of the discussion is to illustrate that a flexible and dynamic relationship may exist that varies from one service provider to another.

In the illustration of FIG. 2, clients 220 represents a varying number of devices 1 through m (m being an integer) that may connect to directory service 210. Clients 220 may be computing devices that are operated by users that have desires to download content from service providers accessible throughout the internet. Such content may be any type of copyrighted media in digital form. This includes, but is not limited to, audio files, video files, and documents.

Service providers 240 represents different types of entities that may provide content to the public. The types of entities are represented by service provider 1 through n (n being an integer) and can represent any entity that has ownership rights, assignment rights, or other authorizations to copyrighted media. The entities in service providers 240 may desire to federate with directory service 210 in order to provide a platform to deliver content and DRM licenses to users located at clients 220. With this federated approach, directory service 210 may enable or disable access to any one of the service providers in service providers 240. Likewise, directory service 210 may restrict access to users located at clients 220 for a variety reasons. Some of the reasons that a user may be prohibited from accessing content may be for non-payment of bills, expiration of licenses, failure to observe the terms of use, unauthorized use, etc. At the same time, directory service 210 may be able to inform users in clients 220 of the status of their current license. For example, if client 230 desires to obtain new content and a new DRM license, directory service 210 may inform client 230 that the current DRM license is still valid and that no new license is required. Another scenario may require directory service 210 to inform client 230 that the DRM license is about to expire, and for the payment of a fee, an extended license may be obtained without proceeding through the complete authentication process.

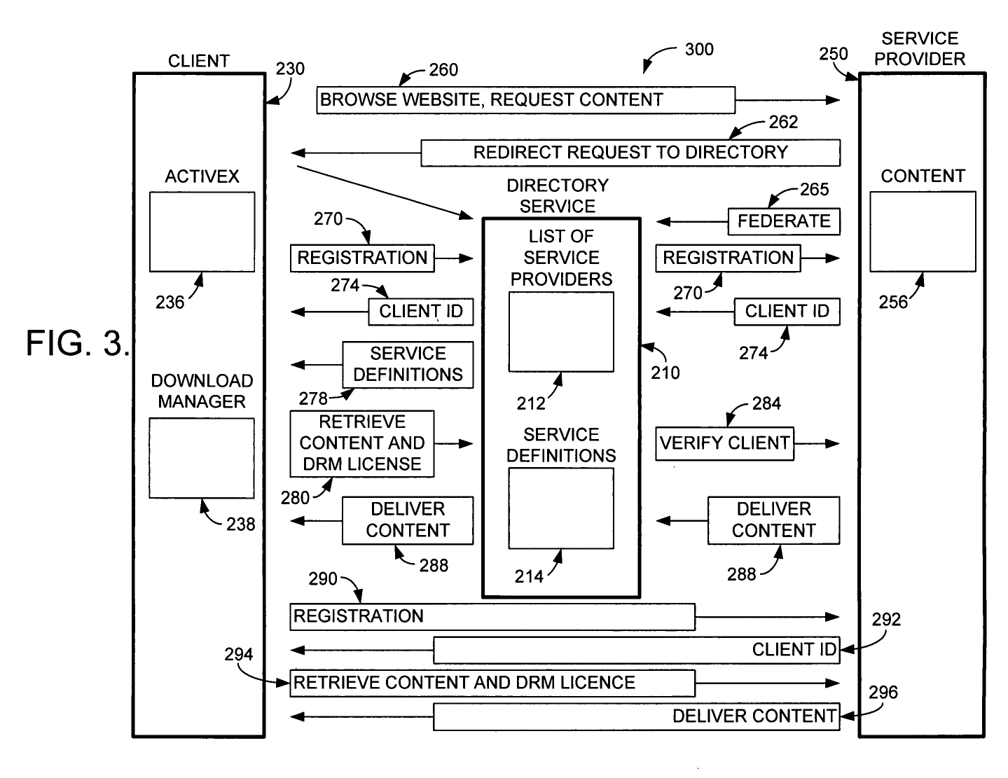

Now turning to FIG. 3, a block diagram is shown illustrating the activities that may occur between directory service 210, client 230, and service provider 250 which were discussed in FIG. 2. FIG. 3 is an isolated view of what transpires between the various devices and is but one embodiment of the present invention. Other types of activities and approaches may occur between different devices. The illustrations and explanations here are merely exemplary of the embodiment to help fully explain the present invention.

One of the services provided by directory service 210 is to maintain a list of service providers in 212. Service providers, also identified as service providers 240, may federate, as noted in 265, with directory service 210 to provide content and DRM licenses. As noted earlier, the approach is federated since each service provider may have a different relationship with directory service 210. In the commercial world, service provider 250 may be controlled by one corporation while directory service 210 may be controlled by another. Alternatively, both service provider 250 and directory service 210 may be controlled by the same corporate entity.

Along with the list of service providers in 212, a service definitions 214 is maintained in directory service 210. Service definitions 214 is information that pertains to service providers that may be used by the clients. The information may vary in service definitions 214 but it may include identification information of service provider 250, the name of the available service(s), the URL that client 230 and service provider 250 may use for the client-server protocol, the valid domains for service provider 250, the operations that service provider 250 may perform with client 230, and other parameters.

While a user is browsing the internet, the user may locate a website, shown by service provider 250, that has a particular audio file, shown as a content 256, that the user desires to obtain. The user, represented by client 230, makes a request as shown by 260 to service provider 250 to obtain the audio file shown by content 256. Service provider 250 responds to the request made by client 230 by redirecting the request in 262 to directory service 210. This redirection may occur for various reasons. First, service provider 250 may not have developed its own client software or it may lack the infrastructure to handle transactions, like DRM activities. Second, service provider 250 may not want to create an infrastructure with servers and security measures in order to handle transactions when there is an available partner, such as directory service 210, to handle those activities. Third, service provider 250 may also lack the billing and administration system needed to deal with various requests from users identified earlier as clients 220 in FIG. 2. Fourth, service provider 250 may desire to control a part of the DRM service whereby directory service 210 performs the registration and authentication of clients but service provider 250 delivers the content and DRM license. In any case, client 230 is redirected to directory service 210 and may start the registration process as shown by 270. Although not shown, client 230 may be required to download and install computer software from directory service 210 in order to proceed with the registration process.

Directory service 210 handles the registration of client 230 on behalf of service provider 250 as one embodiment. Also, as another embodiment, service provider 250 may handle the registration process as shown in 290.

Going back to 270, directory service 210 verifies the registration request with service provider 250, and service provider 250 returns a clientID 274 to directory service 210, if the registration process is successful. ClientID 274 contains various information including a unique ID for client 230 and a secret combination for the DRM challenge if required. One may note that during this phase, the communication between directory service 210 and service provider 250 occurs over a secure communications channel. Another embodiment may employ a non-secure communications channel if desired. Once clientID 274 is received, directory service 210 sends clientID 274 to client 230. Throughout the registration process and the receipt of clientID 274, client 230 contains an ActiveX 236 to facilitate the registration process and receipt of clientID 274. ActiveX 236 is an ActiveX control that is familiar to one of ordinary skill in the art.

During the process of sending clientID 274 to client 230, directory service 210 may send service definitions 278 to client 230. Service definitions 278 may also be sent at an earlier or later time. Service definitions 278 is different from service definitions 214 in that service definitions 278 represents the service definitions for a particular service provider, in this case service provider 250. Service definitions 214 represents all the service providers that may federate with directory service 210. As noted earlier, ActiveX 236 may be involved to facilitate the receipt of service definitions at client 230. ActiveX 236 is locked to service definitions 214 in a software context. With clientID 274 and service definitions 278, client 230 is ready to retrieve content and a DRM license, as shown by 280, from directory service 210. When this occurs, directory service 210 may verify client 230 at 284 with service provider 250. Upon completion of this verification, service provider 250 may deliver content 256 shown by 288 to directory service 210, which in turns delivers content 256 to client 230. Although not discussed here, various protocols and security schemes are employed to enable secure communications between client 230, directory 210, and service provider 250. For example, a public key/private key authentication may be employed to enable the successful transfer and use of the DRM license. Other authentication techniques may be employed as well to meet the needs of the entity that deploys directory service 210.

As discussed earlier, the present invention uses a federated approach to enable service providers to partner with directory service 210. The discussion above mainly focused on an embodiment that illustrated what happens when a service providers relies on directory service 210 to perform most of the tasks on behalf of the service provider. Another relationship may involve client 230 registering directly with service provider 250 as shown by 290 with no involvement of directory service 210. However, directory service 210 may be involved with the delivery of clientID 274 or may not be involved as shown by 292. Furthermore, directory service may be involved with the retrieval of content and the DRM license as shown in 280 or may not be involved as shown by 294 and 296. The point here is to illustrate that service provider 250 has varying degrees of flexibility in using directory service 210. Agreements between directory service 210 and service provider 250 may be made in advance before any services are rendered in order to execute the manner in which activities may occur. Each activity may be selected or withdrawn as it pertains to the involvement of directory service 210 in interfacing with client 230. One scenario may find service provider 250 starting out using all of the services of directory service 210 but gradually reducing those services as service provider 250 grows as an entity. The converse may be implemented as well. Service provider 250 may start out using a few services of directory service 210 and then gradually increase those services to keep pace with growing business needs. For example, the demand for content by users may increase so fast that service provider 250 may be unable to keep pace with fulfilling the demands. Directory service 210 may provide a mechanism to quickly implement a DRM structure to facilitate the needs of service provider 250.

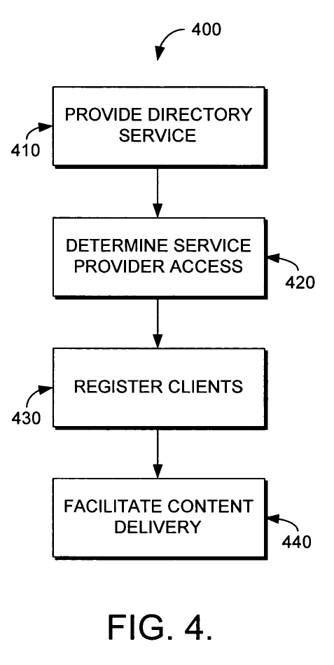

In FIG. 4, a flowchart is shown illustrating an embodiment for implementing the present invention. A central content distribution network is shown in 400. In a step 410, a directory service is provided, identified earlier as directory service 210. One may employ any number of devices to provide the directory service. Mainly, a computing device is deployed in a network with network interfaces to other computing devices. As noted earlier, the computing device may be a computer, server, or switch. Or, it can be multiple servers and computers connected together. One who implements the directory service may procure these devices from any number of commercial suppliers and configure them accordingly. The directory service may have various computer software that enables it to perform the tasks identified for directory service 210 in FIG. 2 and FIG. 3.

As part of the function of the directory service, a list of service providers may be determined along with the access that each may have in regards to the directory service-service provider relationship, shown in a step 420. As discussed in FIG. 3, the present invention encourages a federated approach. Therefore, the access that each service provider may have in step 420 is influenced by the relationship that has been established between the directory service and the service provider. In FIG. 3, we saw directory service 210 and service provider 250 acknowledge this federated approach in 265. Another service provider may have a different relationship with directory service 210, and this will affect the level of access that the service provider uses.

As directory service 210 operates as part of the computing device, it may register clients on behalf of service providers as shown in a step 430. However, this step may be omitted if the service provider desires to register clients directly. Both examples were illustrated in 270 and 290 in FIG. 3. The registration process is crucial to the DRM structure in that a unique ID may be provided by either the service provider or the directory service to identify the particular client. In earlier discussions, this client is client 230. In addition to the unique ID, a secret combination may be passed to the client. This secret combination may contain a DRM challenge including, but not limited to, a public key/private key exchange for authentication. Although not discussed, a user may get to this point with client 230 by paying a fee in order to obtain the necessary information to obtain the content, shown earlier as content 256.

If all goes well with client 230 being properly registered, the directory service facilitates content delivery as shown in a step 440. This step incorporates a broad set of activities which may vary depending on how one may implement an embodiment of the present invention. As shown in FIG. 3, the directory service may deliver the content to client 230, or the directory service may provide service definitions as identified in 278 to client 230 but have no involvement in the retrieval and delivery of content as shown by 294 and 296.

The illustration in FIG. 4 is merely exemplary to show one embodiment of the present invention. The execution of the steps may change depending on the circumstances and desires of the implementer. As note earlier, step 430 may be omitted. In addition, step 420 may be executed before step 410.

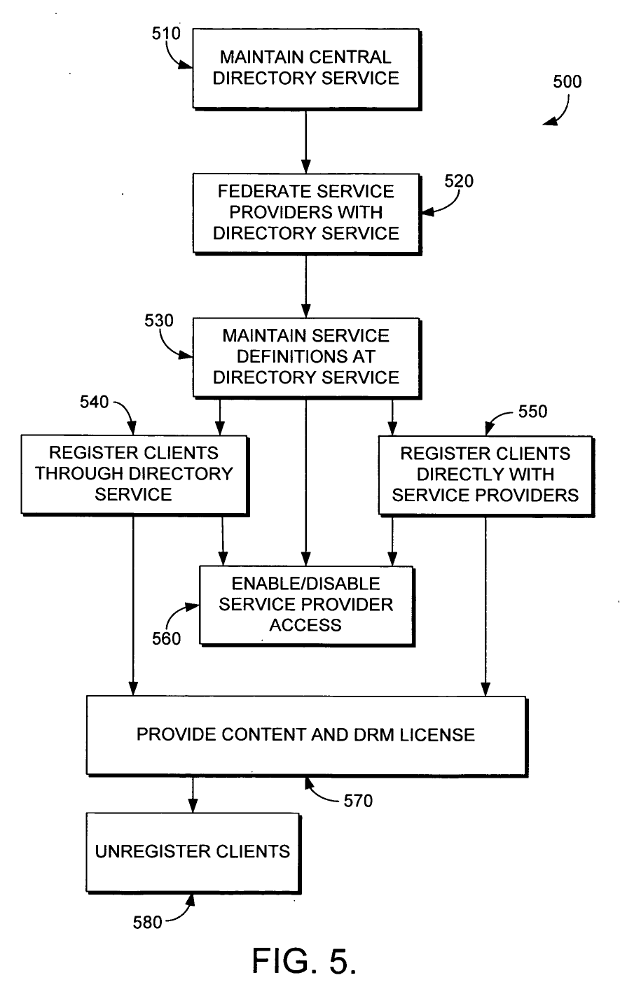

Now turning to FIG. 5, a flowchart is illustrated showing an embodiment of an exemplary operating process for the present invention. Federated delivery network 500 illustrates the present invention but is different from FIG. 4. In a step 510, a central directory service is maintained at a computing device. Embedded in this step are all the necessary functions to get the directory service functioning on the computing device using computer hardware and computer software. Commercially available hardware and software may be used to implement step 510 and a flexible configuration may be implemented. Step 510 is similar to step 410 discussed earlier in FIG. 4.

In a step 520, an ongoing relationship may be established between the directory service and service providers. As discussed in FIG. 4, this relationship may vary from one service provider to another. As one may understand, the relationship identified in step 520 is one where service providers may join and leave at will or according to their respective agreements with the controlling entity administering the directory service. To better understand step 520, four scenarios are discussed below as to the varying relationships that may exist. It is advised that as the scenarios are discussed FIG. 3 may be referred to as a visual reference to understand the scenarios.

In a first scenario, a service provider may want maximum flexibility and independence with its relationship with the directory service. The service provider may want to customize as much as possible as to the relationship with the directory service and implement as much as possible on its own. For example, directory service 210 may add an entry describing the service provider with maximum permissions and the URLs to use as is shown by 212 and 214 in FIG. 3. The service provider may implement its own set of services, as is shown with 292, 294, and 296. A client, earlier identified by client 230, may obtain service definition 278 from directory service 210 and immediately work with the service provider to execute 294 and 296.

In a second scenario, a service provider may work with a directory service which is part of MSN VIDEO of the MICROSOFT CORPORATION of Redmond, Wash. The directory service may include a complement of servers. MSN VIDEO may implement sign-in, billing, client-server communication, content hosting, and DRM license delivery while the directory service may implement client registration and un-registration.

In a third scenario, a service provider may want to implement the full scenario as outlined in FIG. 3 relying on the directory service to handle most of the functions. The service provider could transfer content, identified by content 256, from its servers to the servers associated with directory service 210. The service provider may build a website that would allow others to discover content 256. Whenever a user attempts to retrieve content 256 from the service provider, they will be re-directed to directory service 210. This is identified earlier by 262. The directory service performs sign-in, billing, client registration, client-server communication, content hosting, and DRM license delivery. Note: A user will discover the availability of content at the service provider before being redirected to the directory service.

Finally, in a fourth scenario, a service provider may deploy a similar structure as identified in the third scenario except that the service provider may not have the infrastructure to support a complement of servers. In this case, a user may discover the availability of content at directory service 210 without going to the service provider. The directory service may be equipped to handle all transactions on behalf of the service provider.

In a step 530, service definitions that identify the service providers and their information are maintained at the directory service, as shown in service definitions 214. In a step 540 and a step 550, clients may be registered either with the directory service or directly with the service provider. As shown previously, either approach results in the delivery of clientID 274 to the client.

Although step 520 allows for a variety of relationships between the directory service and the service providers, the directory service can maintain control over the relationship by enabling or disabling access to the service providers as stated in a step 560. Although beyond the scope of this discussion, a non-payment of fees, breach of agreement, or misuse of services may trigger a disable request delivered to the service provider. Likewise, an enable request may result for just as many reasons. Similar to step 560, the directory service may have the authority to un-register clients as indicated by a step 580. Again, many reasons may occur for the directory service to un-register a client such as the expiration of a license, non-payment of fees, or an unauthorized use.

The directory service may also provide content and the DRM license as stated in a step 570. Although shown as an embodiment of the present invention, like others, this step may be omitted and performed directly by the service provider. FIG. 3 shows this step and its omission in 280 and 294.

As stated in FIG. 4, the illustration of FIG. 5 is merely exemplary to show one embodiment of the present invention. The execution of the steps may change depending on the circumstances and desires of the implementer. Several steps may be executed without regard to order, and some steps may be omitted entirely.

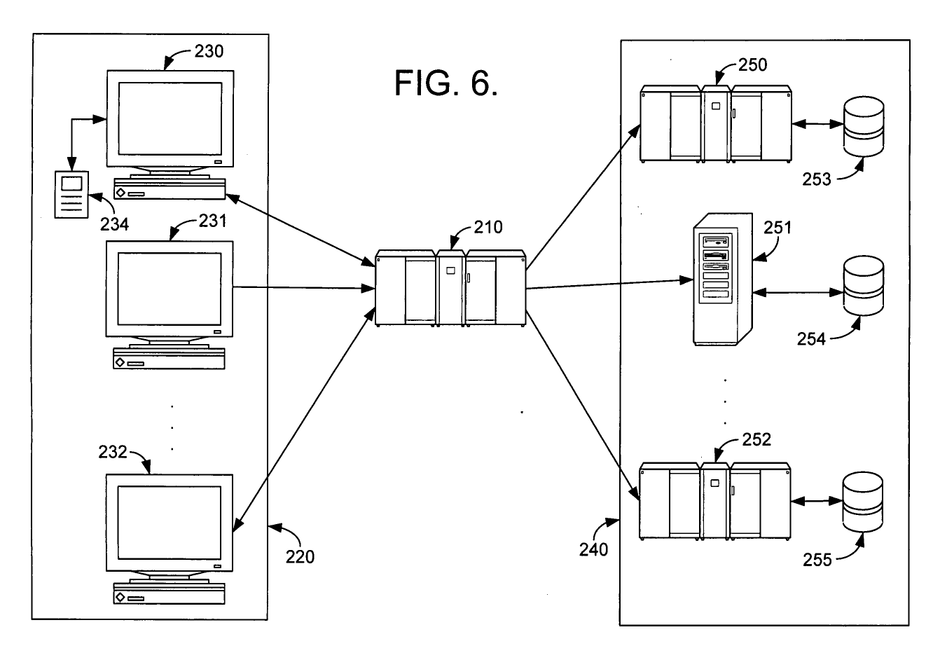

The details of FIG. 6 are a duplication of FIG. 2. Whereas FIG. 2 illustrates a block diagram in block format, FIG. 6 illustrates an exemplary operating environment with actual devices that may be used to implement the present invention. The numerical identifications were kept the same so that a quick reference could be made between the two figures. In FIG. 6, clients 220 may contain a plurality of computing devices. Client 230 may have a portable device 234 attached to it to receive the content (content 256) received at client 230. Portable device 234 may be an MP3 player for example, but it could also be a video player, document reader, or other device that may handle content. Directory service 210 may be a computing device or a complement of servers. Service providers 240 may include computers, servers or other devices with storage devices attached to them as indicated by 253, 254, and 255. Storage devices 253, 254, and 255 may hold content and other information necessary for the deployment of DRM services.

From the aforementioned figures, one may appreciate that the present invention provides a common platform using the directory service to accommodate different entities with different needs to pursue their DRM and non-DRM activities.

The invention claimed is:

1. A computer-implemented method for providing a central content distribution network, comprising:
at a computing device, providing a directory service to define a set of service providers that clients are permitted to use;
operating the directory service to allow the set of service providers to deliver content to clients;
registering a first client with a subset of the set of service providers; and
facilitating the delivery of at least one content from a first service provider to the first client.

2. The computer-implemented method of claim 1, wherein the first service provider is from the subset of the set of service providers where the first client is registered.

3. The computer-implemented method of claim 2, wherein registering the first client with the subset of the set of service providers comprises performing a registration of the first client by the directory service for the subset of the set of service providers.

4. A computer-readable medium having instructions stored thereon for performing the method of claim 1.

5. A computer system for operating a federated delivery network, comprising:
at least one computing device operable in a network to maintain a central directory service;
the at least one computing device operable with a network connection to one or more service providers and one or more clients;
the central directory service operable to control which one or more service providers are permitted in the network to provide content to the one or more clients; and
the central directory service operable to maintain a description of the allowed services from the one or more service providers.

6. The computer system of claim 5, further comprising the central directory service operable to facilitate a registration of the one or more clients with the one or more service providers.

7. The computer system of claim 6, wherein when a first client attempts to register with a first service provider, the central directory service contacts the first service provider using a protocol, retrieve at least a unique identifier assigned to the first client, and delivers the at least unique identifier to the first client.

8. The computer system of claim 5, further comprising the central directory service operable to enable or disable access of the one or more service providers to the central directory service.

9. The computer system of claim 5, wherein the description is selected from the group comprising text, binary, and XML.

10. The computer system of claim 9, wherein the XML description is located in an HTTP-accessible location known to the one or more clients.

11. The computer system of claim 9, wherein the XML description is dynamically-generated.

12. The computer system of claim 5, wherein the description contains a set of service definitions, the set of service definitions comprises at least one of a name of the service, a URL to use for a protocol, valid domains for the one or more service providers, and the operations that the one or more service providers are allowed to perform with the one or more clients.

13. The computer system of claim 5, further comprising one or more service providers operable to register one or more clients without the central delivery service.

14. The computer system of claim 5, further comprising one or more service providers operable to provide content to the one or more clients.

15. The computer system of claim 14, wherein a first client operates a download manager and implements an ActiveX control, the first client communicates with a first service provider.

16. The computer system of claim 5, further comprising the central directory service operable to provide content to the one or more clients.

17. The computer system of claim 5, wherein the computing device comprises one or more computers connected together.

18. A computer-readable medium having instructions stored thereon for performing the system of claim 5.

19. A computer-implemented method for operating a federated delivery network, comprising:
maintaining a central directory service at a computing device;
operating the computing device with a network connection to one or more service providers and one or more clients;
controlling by the central directory service which one or more service providers are permitted in the network to provide content to the one or more clients; and
maintaining a description of the allowed services by the central directory service from the one or more service providers.

20. The computer-implemented method of claim 19, further comprising operating the central directory service to facilitate a registration of the one or more clients with the one or more service providers.

21. The computer-implemented method of claim 19, further comprising operating the central directory service to provide content to the one or more clients.

22. A computer-readable medium having instructions stored thereon for performing the method of claim 19.
